(19) United States
(12) Patent Application Publication
(10) Pub. No.: US 2025/0277403 A1
(43) Pub. Date: Sep. 4, 2025

(54) TRANSMISSION STRUCTURE FOR SYNCHRONOUS ROTATION OF LOUVER BLADES

(71) Applicant: Zhejiang Risong Science and Technology Co., Ltd., Taizhou (CN)

(72) Inventor: Xuye LIN, Taizhou (CN)

(73) Assignee: Zhejiang Risong Science and Technology Co., Ltd., Taizhou (CN)

(21) Appl. No.: 19/210,886

(22) Filed: May 16, 2025

Related U.S. Application Data
(63) Continuation of application No. PCT/CN2023/132101, filed on Nov. 16, 2023.

(30) Foreign Application Priority Data
Nov. 18, 2022 (CN) 202223076808.7

(51) Int. Cl. E06B 7/096

(52) U.S. Cl. CPC E06B 7/096

(57) ABSTRACT

A transmission structure for synchronous rotation of louver blades includes a mounting bar inserted in a window sash vertical column. The mounting bar has an open front side and includes a left side plate, a right side plate and a rear side plate; a left rack is slidably arranged on the right side of the left side plate; a right rack is slidably arranged on the left side of the right side plate; a plurality of gears arranged at intervals in the vertical direction are meshed between the left rack and the right rack; through holes, the number and positions of which match the gears, are formed in the rear side plate; the rear end of a rotating shaft for driving blades to rotate passes through the window sash vertical column to be detachably connected to the gears.

### CROSS-REFERENCE TO RELATED APPLICATIONS

This application is a continuation of International Application No. PCT/CN2023/132101, filed on Nov. 16, 2023, which claims priority to Chinese Patent Application No. 202223076808.7, filed on Nov. 18, 2022. All of the aforementioned applications are incorporated herein by reference in their entireties.

### TECHNICAL FIELD

This application pertains to the technical field of louvers, specifically to a hidden louver wand transmission structure.

### BACKGROUND

To facilitate the synchronous opening and closing of louver blades, there are typically three methods: The first method involves connecting a wand at the middle position of each blade to achieve synchronous rotation and angle adjustment of the blades, such wand being commonly known as an exposed wand. This wand obstructs the view and is unpopular in some countries. The second method involves drilling a hole at one end of each blade and fixing an alloy wand with equal hole spacing to each blade using a screw, while inserting a plastic pin with two ends at the center hole of the blade to connect with a window sash vertical column. Although this method, with the wand located at the side and rear of the blade, alleviates view obstruction, complete unobstructed vision cannot be achieved. The third method involves providing two racks within the window sash vertical column, with a gear at an end of the blade to drive the blade to rotate. The gear passes through the window sash vertical column, is positioned between the two racks, and meshes with them. Moving the gear drives its rotation, thereby synchronously rotating the blades.

Although the third method effectively addresses the issue of view obstruction, it has shortcomings: Firstly, during the process of the gear passing through the window sash vertical column to mesh with the racks, the position of the racks needs to be adjusted, so as to engage with the gear. However, since a plurality of blades are typically provided, requiring a plurality of gears, the rack positions must be repeatedly adjusted. As the racks are located inside the window sash vertical column, the meshing condition between the gear and the racks cannot be clearly observed, leading to inconvenient mounting. Additionally, after mounting, the ends of the two racks are likely to be uneven, which may limit the rotation angle of the blades. Secondly, to facilitate blade rotation, the gear and racks are typically meshed with a gap. When the assembled window sash vertical column is moved, the gear is prone to falling off.

### SUMMARY

An objective of this application is to provide a transmission structure for synchronous rotation of louver blades, which facilitates observation and adjustment of the meshing position between gears and racks, is easy to mount, and does not result in restricted blade rotation after mounting. Additionally, during the movement of a mounting bar and a window sash vertical column, the gear does not fall off, facilitating subsequent assembly.

This application is implemented as follows.

The transmission structure for synchronous rotation of louver blades includes a mounting bar inserted in a window sash vertical column, where the mounting bar has a front side opening, the mounting bar includes a left side plate, a right side plate, and a rear side plate, a left rack is slidably arranged on a right side of the left side plate, a right rack is slidably arranged on a left side of the right side plate, a plurality of gears arranged at intervals in a vertical direction are meshed between the left rack and the right rack, a plurality of through holes corresponding to the gears in number and position are formed in the rear side plate in the vertical direction, a rear end of a rotating shaft for driving the blade to rotate passes through the window sash vertical column and is detachably connected to the gear, and the rotating shaft is rotated by the gear; where
mounting columns are arranged at rear ends of the gears, and the gears are fixed to the rear side plate by passing the mounting columns through the through holes to be detachably connected to fixing blocks; or
a limiting block is arranged on a rear side of the rear side plate, a connecting column is arranged at a front end of the limiting block, and the gear is fixed to the rear side plate by passing the connecting column through the through hole to be detachably connected to the gear.

In the transmission structure for synchronous rotation of louver blades, the gear and the mounting column are an integral structure.

In the transmission structure for synchronous rotation of louver blades, a detachable connection method between the mounting column and the fixing block may be: The fixing block sleeves the mounting column, the mounting column is provided with an annular groove, an inner ring of the fixing block is provided with a clamped block, and the mounting column is detachably connected to the fixing block by clamping the clamped block into the annular groove.

In the transmission structure for synchronous rotation of louver blades, the detachable connection method between the mounting column and the fixing block may alternatively be: The fixing block sleeves the mounting column, the mounting column is provided with an external thread, the fixing block is provided with an internal thread, and the mounting column is detachably connected to the fixing block by screwing the external thread with the internal thread.

In the transmission structure for synchronous rotation of louver blades, a detachable connection method between the connecting column and the gear may be: The gear sleeves the connecting column and is clamped to the connecting column.

In the transmission structure for synchronous rotation of louver blades, the detachable connection method between the connecting column and the gear may alternatively be: The gear sleeves the connecting column and is screwed to the connecting column.

In the transmission structure for synchronous rotation of louver blades, an inner side surface of the clamped block includes a circular table surface at a front end and a cylindrical surface on a rear side of the circular table surface, a diameter of the circular table surface decreases from front to rear, and a front end surface and a rear end surface of the clamped block are planes.

In the transmission structure for synchronous rotation of louver blades, more than two clamped blocks are uniformly distributed circumferentially.

In the transmission structure for synchronous rotation of louver blades, a detachable connection method between the rotating shaft and the gear may be: A polygonal hole is arranged on a side of the gear away from the mounting column, a polygonal insertion shaft adapted to the polygonal hole is arranged at the rear end of the rotating shaft, and the gear drives the rotating shaft to rotate by inserting the polygonal insertion shaft into the polygonal hole.

In the transmission structure for synchronous rotation of louver blades, a diameter of the rotating shaft is smaller than a tip circle diameter of the gear.

In the transmission structure for synchronous rotation of louver blades, left sliders are respectively arranged on front and rear sides of the left rack, a left guide groove for the left slider to slide in is arranged on the right side of the left side plate, right sliders are respectively arranged on front and rear sides of the right rack, and a right guide groove for the right slider to slide in is arranged on the left side of the right side plate.

In the transmission structure for synchronous rotation of louver blades, a left slide groove is arranged on a left side of the left side plate, a right slide groove is arranged on a right side of the right side plate, and a left guide rail adapted to the left slide groove and a right guide rail adapted to the right slide groove are arranged in the window sash vertical column.

In the transmission structure for synchronous rotation of louver blades, the left side of the left side plate is provided with more than two left vertical panels, where the left slide groove is formed between two adjacent left vertical panels; and the right side of the right side plate is provided with more than two right vertical panels, where the right slide groove is formed between two adjacent right vertical panels.

In the transmission structure for synchronous rotation of louver blades, a connection method of the rotating shaft driving the blade to rotate is: Two pins are arranged at a front end of the rotating shaft, two pin holes for insertion of the pins are arranged in an end portion of the blade, and the rotating shaft drives the blade to rotate by inserting the pins into the pin holes.

The prominent advantages of this application compared to the prior art are as follows.

The front side opening of the mounting bar in this application facilitates observation and adjustment of the meshing position of the gear with the left rack and the right rack, making mounting convenient and preventing restricted blade rotation after mounting. The gear in this application is fixed to the rear side plate by detachably connecting the mounting column and the fixing block, allowing the left rack, the right rack, and the gear to be fixed on the mounting bar to form an integral prefabricated component, rather than separate individual parts. During the movement of the mounting bar and the window sash vertical column, the gear does not fall off, facilitating subsequent assembly.

### BRIEF DESCRIPTION OF THE DRAWINGS

FIG. 1 is a perspective view of this application.

FIG. 2 is a top view of this application.

FIG. 3 is an exploded view of this application.

FIG. 4 is a top view of a mounting bar of this application.

FIG. 5 is a perspective view of a gear and a mounting column of this application.

FIG. 6 is a perspective view of a fixing block of this application.

### DETAILED DESCRIPTION OF THE EMBODIMENTS

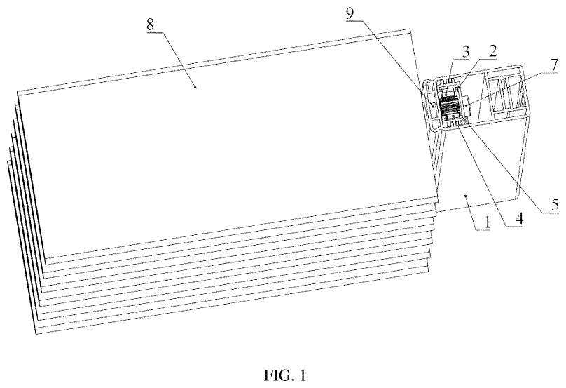

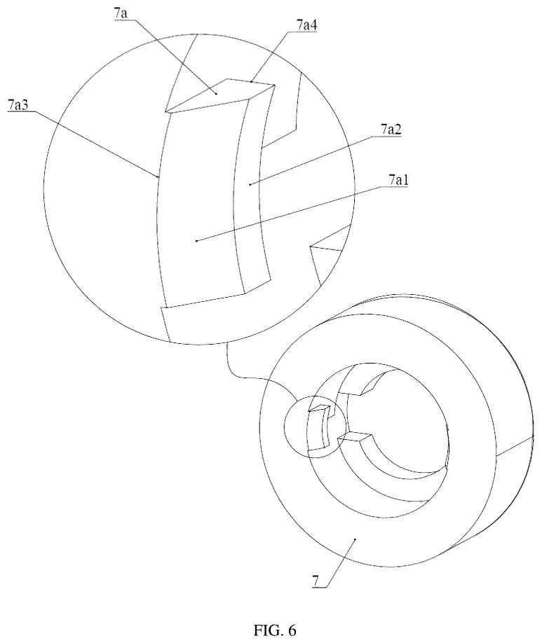

The following provides a further description of this application with specific embodiments, referring to FIGS. 1 to 6.

### Embodiment 1

A transmission structure for synchronous rotation of louver blades is provided, including a mounting bar 2 inserted in a window sash vertical column 1, where the mounting bar 2 has a front side opening, the mounting bar 2 includes a left side plate 2a, a right side plate 2b, and a rear side plate 2c, a left rack 3 is slidably arranged on a right side of the left side plate 2a, a right rack 4 is slidably arranged on a left side of the right side plate 2b, a plurality of gears 5 arranged at intervals in a vertical direction are meshed between the left rack 3 and the right rack 4, a plurality of through holes 2cl corresponding to the gears 5 in number and position are formed in the rear side plate 2c in the vertical direction, a rear end of a rotating shaft 9 for driving the blade 8 to rotate passes through the window sash vertical column 1 and is detachably connected to the gear 5, and the rotating shaft 9 is rotated by the gear 5. Mounting columns 6 are arranged at rear ends of the gears 5, and the gears 5 are fixed to the rear side plate 2c by passing the mounting columns 6 through the through holes 2cl to be detachably connected to fixing blocks 7.

The assembly process of this application: As shown in FIGS. 1 to 4, first, the left rack 3 is placed on the right side of the left side plate 2a, the right rack 4 is placed on the left side of the right side plate 2b, and the gear 5 is placed between the left rack 3 and the right rack 4. Due to the front side opening of the mounting bar 2, it is easy to adjust the meshing position of the gear 5 with the left rack 3 and the right rack 4. The mounting column 6 provided at the rear end of the gear 5 passes through the through hole 2cl of the rear side plate 2c to be detachably connected to the fixing block 7, securing the gear 5 to the rear side plate 2c. After all the gears 5 are mounted, the mounting bar 2 is inserted into the window sash vertical column 1, and finally, the rotating shaft 9 of the blade 8 is passed through the window sash vertical column 1 to be detachably connected to the gear 5.

The front side opening of the mounting bar 2 in this application facilitates observation and adjustment of the meshing position of the gear 5 with the left rack 3 and the right rack 4, making mounting convenient and preventing restricted blade rotation after mounting. The gear 5 in this application is fixed to the rear side plate 2c by detachably connecting the mounting column 6 and the fixing block 7, allowing the left rack 3, the right rack 4, and the gear 5 to be fixed on the mounting bar 2 to form an integral prefabricated component, rather than separate individual parts. During the movement of the mounting bar 2 and the window sash vertical column, the gear 5 does not fall off, facilitating subsequent assembly.

Preferably, the gear 5 and the mounting column 6 are an integral structure.

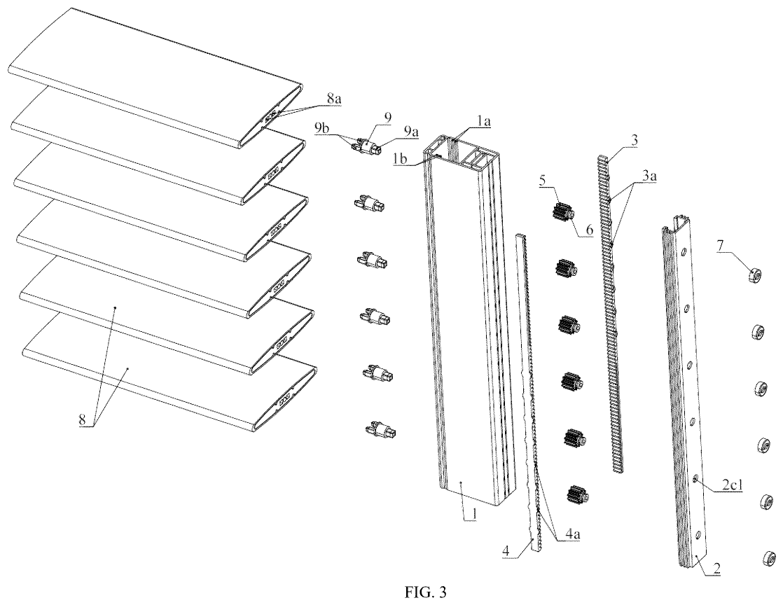

The detachable connection method between the mounting column 6 and the fixing block 7: As shown in FIGS. 3, 5, and 6, the fixing block 7 sleeves the mounting column 6, the mounting column 6 is provided with an annular groove 6a, an inner ring of the fixing block 7 is provided with a clamped block 7a, and the mounting column 6 is detachably connected to the fixing block 7 by clamping the clamped block 7a into the annular groove 6a. The structure is simple, easy to assemble, and convenient to process.

The structure of the clamped block 7a: As shown in FIG. 6, an inner side surface of the clamped block 7a includes a circular table surface 7al at the front end and a cylindrical surface 7a2 on the rear side of the circular table surface 7al. The diameter of the circular table surface 7al decreases from front to rear, facilitating the clamping of the clamped block 7a into the annular groove 6a. The front end surface 7a3 and the rear end surface 7a4 of the clamped block 7a are planes, making it difficult for the clamped block 7a to disengage from the annular groove 6a.

To facilitate clamping and ensure a secure connection, more than two clamped blocks 7a are uniformly distributed circumferentially. In this embodiment, two clamped blocks 7a are uniformly distributed circumferentially.

The detachable connection method between the rotating shaft 9 and the gear 5: A polygonal hole 5a is arranged on a side of the gear 5 away from the mounting column 6, a polygonal insertion shaft 9a adapted to the polygonal hole 5a is arranged at the rear end of the rotating shaft 9, and the gear 5 drives the rotating shaft 9 to rotate by inserting the polygonal insertion shaft 9a into the polygonal hole 5a. The structure is simple, easy to assemble, and convenient to process. Additionally, the rotating shaft 9 can be tightly fitted with the gear 5, and during the movement of the window sash vertical column 1, the rotating shaft 9 is not prone to falling off. In this embodiment, the polygonal hole 5a is a quadrilateral hole, and the polygonal insertion shaft 9a is a quadrilateral insertion shaft.

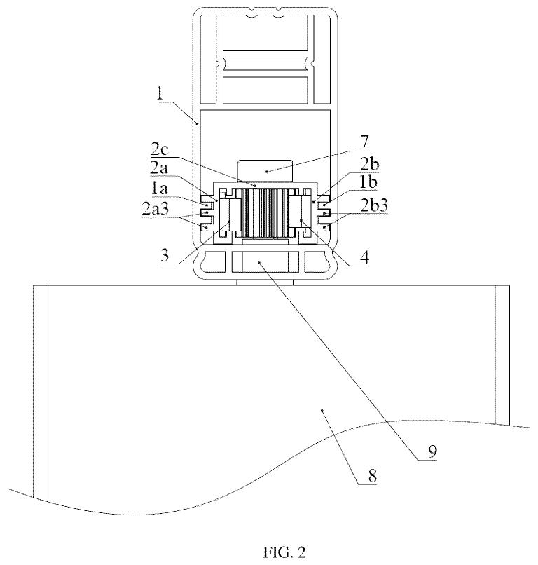

To ensure that the rotating shaft 9 does not protrude from the surface of the blade 8, maintaining overall aesthetics, as shown in FIG. 2, the diameter of the rotating shaft 9 is smaller than the tip circle diameter of the gear 5. In the prior art, the rotating shaft 9 must have a diameter greater than or equal to the tip circle diameter of the gear 5; otherwise, an excessive gap between the rotating shaft 9 and the window sash vertical column 1 would cause the rotating shaft 9 to rotate off-center, leading to abnormal rotation of the blade 8. However, due to the thickness limitation of the blade 8, if the diameter of the rotating shaft 9 is too large, the surface of the blade 8 is not exposed, resulting in an unaesthetic appearance.

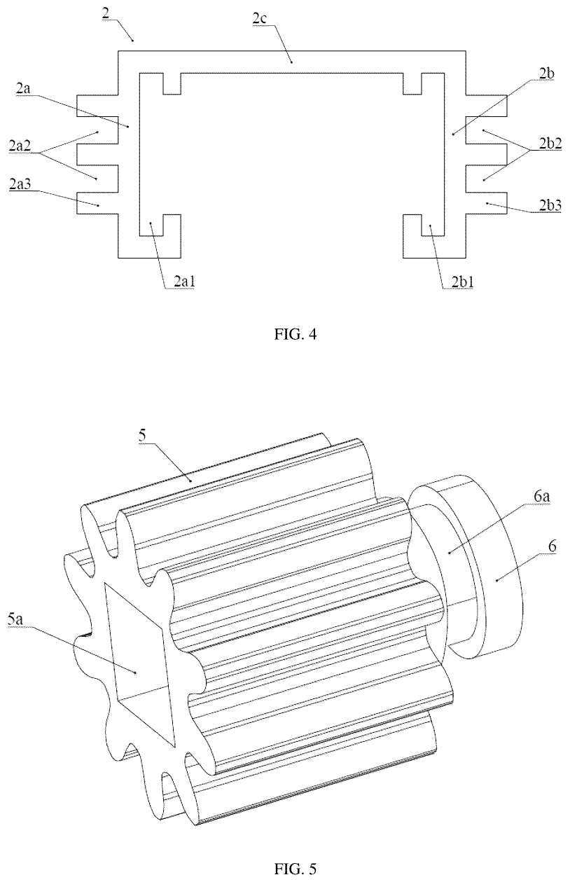

To provide lateral and longitudinal limitation for the left rack 3, as shown in FIGS. 3 and 4, left sliders 3a are respectively arranged on front and rear sides of the left rack 3, and a left guide groove 2al for the left slider 3a to slide in is arranged on the right side of the left side plate 2a. To provide lateral and longitudinal limitation for the right rack 4, as shown in FIGS. 3 and 4, right sliders 4a are respectively arranged on front and rear sides of the right rack 4, and a right guide groove 2b1 for the right slider 4a to slide in is arranged on the left side of the right side plate 2b.

To facilitate the insertion of the mounting bar 2 into the window sash vertical column 1, a left slide groove 2a2 is arranged on a left side of the left side plate 2a, a right slide groove 2b2 is arranged on a right side of the right side plate 2b, and a left guide rail 1a adapted to the left slide groove 2a2 and a right guide rail 1b adapted to the right slide groove 2b2 are arranged in the window sash vertical column 1.

The structure of the left slide groove 2a2: The left side of the left side plate 2a is provided with more than two left vertical panels 2a3, where the left slide groove 2a2 is formed between two adjacent left vertical panels 2a3. The structure of the right slide groove 2b2: The right side of the right side plate 2b is provided with more than two right vertical panels 2b3, where the right slide groove 2b2 is formed between two adjacent right vertical panels 2b3. In this embodiment, three left vertical panels 2a3 and three right vertical panels 2b3 are provided, two left slide grooves 2a2 and two right slide grooves 2b2 are provided, and two left guide rails 1a and two right guide rails 1b are provided.

A connection method of the rotating shaft 9 driving the blade 8 to rotate is: Two pins 9b are arranged at a front end of the rotating shaft 9, two pin holes 8a for insertion of the pins 9b are arranged in an end portion of the blade 8, and the rotating shaft 9 drives the blade 8 to rotate by inserting the pins 9b into the pin holes 8a.

### Embodiment 2

This embodiment is basically the same as Embodiment 1 in structure, with the main difference being that a limiting block is arranged on a rear side of the rear side plate 2c, a connecting column is arranged at a front end of the limiting block, and the gear 5 is fixed to the rear side plate 2c by passing the connecting column through the through hole 2cl to be detachably connected to the gear 5.

The detachable connection method between the connecting column and the gear 5 may be: The gear 5 sleeves the connecting column and is clamped to the connecting column. The detachable connection method between the connecting column and the gear 5 may alternatively be: The gear 5 sleeves the connecting column and is screwed to the connecting column. In this embodiment, the gear 5 sleeves the connecting column and is clamped to the connecting column.

The above embodiments are only some of the preferred embodiments of this application and are not intended to limit the scope of this application. Therefore, all equivalent changes made in accordance with the shape, structure, and principles of this application shall be covered within the protection scope of this application.

What is claimed is:

1. A transmission structure for synchronous rotation of louver blades, comprising a mounting bar inserted in a window sash vertical column, wherein
the mounting bar has a front side opening, the mounting bar comprises a left side plate, a right side plate, and a rear side plate, a left rack is slidably arranged on a right side of the left side plate, a right rack is slidably arranged on a left side of the right side plate, a plurality of gears arranged at intervals in a vertical direction are meshed between the left rack and the right rack, a plurality of through holes corresponding to the gears in number and position are formed in the rear side plate in the vertical direction, a rear end of a rotating shaft for driving the blade to rotate passes through the window sash vertical column and is detachably connected to the gear, and the rotating shaft is rotated by the gear; and
mounting columns are arranged at rear ends of the gears, and the gears are fixed to the rear side plate by passing the mounting columns through the through holes to be detachably connected to fixing blocks.

2. The transmission structure for synchronous rotation of louver blades according to claim 1, wherein the fixing block sleeves the mounting column, the mounting column is provided with an annular groove, an inner ring of the fixing block is provided with a clamped block, and the mounting column is detachably connected to the fixing block by clamping the clamped block into the annular groove.

3. The transmission structure for synchronous rotation of louver blades according to claim 2, wherein an inner side surface of the clamped block comprises a circular table surface at a front end and a cylindrical surface on a rear side of the circular table surface, a diameter of the circular table surface decreases from front to rear, and a front end surface and a rear end surface of the clamped block are planes.

4. The transmission structure for synchronous rotation of louver blades according to claim 2, wherein more than two clamped blocks are uniformly distributed circumferentially.

5. The transmission structure for synchronous rotation of louver blades according to claim 1, wherein a polygonal hole is arranged on a side of the gear away from the mounting column, a polygonal insertion shaft adapted to the polygonal hole is arranged at the rear end of the rotating shaft, and the gear drives the rotating shaft to rotate by inserting the polygonal insertion shaft into the polygonal hole.

6. The transmission structure for synchronous rotation of louver blades according to claim 1, wherein a diameter of the rotating shaft is smaller than a tip circle diameter of the gear.

7. The transmission structure for synchronous rotation of louver blades according to claim 1, wherein left sliders are respectively arranged on front and rear sides of the left rack, a left guide groove for the left slider to slide in is arranged on the right side of the left side plate, right sliders are respectively arranged on front and rear sides of the right rack, and a right guide groove for the right slider to slide in is arranged on the left side of the right side plate.

8. The transmission structure for synchronous rotation of louver blades according to claim 1, wherein a left slide groove is arranged on a left side of the left side plate, a right slide groove is arranged on a right side of the right side plate, and a left guide rail adapted to the left slide groove and a right guide rail adapted to the right slide groove are arranged in the window sash vertical column.

9. The transmission structure for synchronous rotation of louver blades according to claim 1, wherein two pins are arranged at a front end of the rotating shaft, two pin holes for insertion of the pins are arranged in an end portion of the blade, and the rotating shaft drives the blade to rotate by inserting the pins into the pin holes.

10. A transmission structure for synchronous rotation of louver blades, comprising a mounting bar inserted in a window sash vertical column, wherein
the mounting bar has a front side opening, the mounting bar comprises a left side plate, a right side plate, and a rear side plate, a left rack is slidably arranged on a right side of the left side plate, a right rack is slidably arranged on a left side of the right side plate, a plurality of gears arranged at intervals in a vertical direction are meshed between the left rack and the right rack, a plurality of through holes corresponding to the gears in number and position are formed in the rear side plate in the vertical direction, a rear end of a rotating shaft for driving the blade to rotate passes through the window sash vertical column and is detachably connected to the gear, and the rotating shaft is rotated by the gear; and
a limiting block is arranged on a rear side of the rear side plate, a connecting column is arranged at a front end of the limiting block, and the gear is fixed to the rear side plate by passing the connecting column through the through hole to be detachably connected to the gear.

11. The transmission structure for synchronous rotation of louver blades according to claim 10, wherein a diameter of the rotating shaft is smaller than a tip circle diameter of the gear.

12. The transmission structure for synchronous rotation of louver blades according to claim 10, wherein left sliders are respectively arranged on front and rear sides of the left rack, a left guide groove for the left slider to slide in is arranged on the right side of the left side plate, right sliders are respectively arranged on front and rear sides of the right rack, and a right guide groove for the right slider to slide in is arranged on the left side of the right side plate.

13. The transmission structure for synchronous rotation of louver blades according to claim 10, wherein a left slide groove is arranged on a left side of the left side plate, a right slide groove is arranged on a right side of the right side plate, and a left guide rail adapted to the left slide groove and a right guide rail adapted to the right slide groove are arranged in the window sash vertical column.

14. The transmission structure for synchronous rotation of louver blades according to claim 10, wherein two pins are arranged at a front end of the rotating shaft, two pin holes for insertion of the pins are arranged in an end portion of the blade, and the rotating shaft drives the blade to rotate by inserting the pins into the pin holes.
